(19) United States
(12) Patent Application Publication
(10) Pub. No.: US 2003/0115134 A1
(43) Pub. Date: Jun. 19, 2003

(54) Credit account integration method

(76) Inventors: Kimio Kikuchi, Kawasaki (JP); Shigehiko Terashima, Kawasaki-shi (JP); Kimiko Terashima, Shinjuku (JP)

Correspondence Address: STAAS & HALSEY LLP, 700 11TH STREET, NW, SUITE 500, WASHINGTON, DC, 20001, US

(21) Appl. No.: 10/106,878

(22) Filed: Mar. 27, 2002

(30) Foreign Application Priority Data
Dec. 18, 2001 (JP) 2001-384075

(51) Int. Cl. G06F 17/60

(52) U.S. Cl. 705/38

(57) ABSTRACT

A credit account management system comprises a refund method management unit, and a credit limit setting unit. The refund method management unit receives the designation of a refund method of the outstanding credit-loan amount in the credit account after integration from the user, and sets the refund method of the outstanding credit-loan amount in the credit account after integration. After credit accounts are integrated, the outstanding credit-loan amount is refunded according to the refund method set by the refund method management unit. The credit limit setting unit compares the outstanding credit-loan amount in the credit account after integration and a target credit limit which is expected to be given in the credit account after integration, and sets a credit limit in the credit account after integration based on the comparison result.

### BACKGROUND OF THE INVENTION

1. Field of the Invention

The present invention relates to a system which manages a credit account, and more specifically, to a credit account management system which is suitable when a plurality of credit accounts are integrated into one credit account.

2. Description of the Related Art

A user of a credit card has a credit account. This credit account is individually managed by each credit-card issuing organization. Also, the user can have his or her credit account in each of a plurality of the credit-card issuing organizations. In this case, the total amount in which the credit limit of each credit account is summed up is a substantial credit limit which the user can use in his or her entire credit accounts. Enumerated as organizations which issue credit cards are, for example, banks, credit-sale companies, distribution business companies, etc.

Recently, some of the credit-card issuing organizations have carried out M&A (merger and acquisition). When M&A is carried out, the credit accounts which were individually managed by the credit-card issuing organizations concerned are most likely to be integrated into one credit account after the deferment of a specified period. There was a problem, therefore, in that the refund method which a user had considered before the credit accounts were integrated into one credit account was changed owing to said integration regardless of the user's intention or plan.

For example, let us suppose that the user is refunding to two credit accounts before integration every month 100,000 yen each in a revolving method with 100,000 yen as an upper-limit refund amount, namely 200,000 yen in total every month. However, after the two credit accounts are integrated into one credit account, the user has to refund an outstanding credit-loan amount by 100,000 yen every month based on the refund method adopted in the credit account which continues to exist after integration. In other words, although the user used to refund 200,000 yen every month before said integration took place, the refund method is changed to the one in which the user has to refund the outstanding credit-loan amount by 100,000 yen every month after said integration takes place. This means that the refund method in which the user originally planned to refund the outstanding credit-loan amount is unilaterally changed by the credit-card issuing organizations after said integration takes place. Also, there occurs a problem in that in such a case as mentioned above, the period during which the user has to refund the outstanding credit-loan amount becomes longer than he originally expected before said integration takes place, thus causing him or her to bear increased interest accruing therefrom.

Also, the credit limit of a user having credit accounts in a plurality of credit-card issuing organizations is substantially lowered, by integrating a plurality of credit accounts into one credit account. FIG. 1 shows the substantial change of credit limits before and after a plurality of credit accounts are integrated into one credit account. Let us suppose that a user has a credit account with the credit limit of 2,000,000 yen in both credit-card issuing organization A and credit-card issuing organization B. The substantial credit limit given to the user is 4,000,000 yen which is the sum of the credit limits of both the organizations, as shown in FIG. 1. However, when the credit accounts which the user had in both the organizations are integrated into one credit account owing to the merger, etc. of both the organizations, the substantial credit limit given to the user is 2,000,000 yen as shown in FIG. 1. That means, therefore, that the substantial credit limit given to the user has been sharply lowered owing to the integration of the credit accounts after the lapse of a certain deferment period.

For example, let us suppose that the user believes that the credit limit given to him is 2,000,000 yen each in two credit accounts before integration, namely 4,000,000 yen in total, and actually uses a credit-loan amount of more than 2,000,000 yen. If the credit limit is suddenly lowered to 2,000,000 yen owing to the integration of the two credit accounts, the user is requested by the merged credit card issuing organization to refund the amount which exceeds 2,000,000 yen in a lump sum. Consequently, the user not only has to change the refund plan which he originally considered, but also has to spend an unexpected expense owing to the integration of the credit accounts, thus causing him or her inconveniences all the more.

### SUMMARY OF THE INVENTION

The purpose of the present invention is to make it possible to manage credit accounts in such a way that the inconveniences and disadvantages which users suffer owing to the integration of credit accounts can be reduced as much as possible.

According to an embodiment of the present invention, an account management method comprising: when a plurality of credit accounts are integrated into one credit account, judging whether an outstanding credit-loan amount in the credit account after integration is larger than a target limit which is expected to be the credit limit in the credit account after integration; when it is judged that the outstanding credit-loan amount in the credit account after integration is larger than the target limit, setting an equal to or larger amount than the outstanding credit-loan amount as the credit limit in the credit account after integration; when it is judged that the outstanding credit-loan amount in the credit account after integration is equal to or smaller than the target limit, setting the same amount as the target limit as the credit limit in the credit account after integration.

Then, it becomes possible to avoid setting the same amount as the target limit as the credit limit in the credit account after integration when a plurality of credit accounts are integrated into one credit account if the outstanding credit-loan amount in the credit account after integration is larger than the target limit, and to set a larger amount than the outstanding credit-loan amount in the credit account after integration as the credit limit.

Consequently, it also becomes possible to solve a problem in that as the result that a substantial credit limit is sharply lowered owing to the integration of credit accounts, the user of that integrated credit account is requested by the credit-card issuing organization to refund the amount exceeding the credit limit which has been lowered. In addition, it is possible to accomplish the above-mentioned purpose of reducing the inconveniences and disadvantages given to the user owing to the integration of credit accounts.

Also, the above-mentioned account management method may further include: updating the outstanding credit-loan amount in the credit account after integration at a specified timing; and if the credit limit in the credit account after integration does not coincide with the target limit; and re-setting the credit limit in the credit account after integration by making the above-mentioned judgement based on the updated outstanding credit-loan amount. In other words, when a larger amount than the outstanding credit-loan amount in the credit account after integration is set as the credit limit in the credit account after integration, the credit limit in the credit account after integration is lowered stepwise.

In this way, it is possible to set the credit limit in the credit account after integration so as to gradually come nearer to the target limit as the refund of the outstanding credit-loan advances until the credit limit in the credit account after integration is set to the same amount as the target limit.

Furthermore, said account management method may further include: receiving via a network a designation of a refund method for refunding the outstanding credit-loan amount in the credit account after integration from a user of the credit account; calculating a refund schedule for refunding the outstanding credit-loan amount in the credit account after integration based on the refund method; and informing the user of the refund schedule via a network.

By setting the refund schedule in the credit account after integration based on the designation of the user, it is possible to prevent the user from suffering from inconveniences and disadvantages which occur due to the change of the refund schedule in which the user originally expects to refund the outstanding credit-loan amount before the credit accounts are integrated into one credit account regardless of the user's intention.

In the meantime, some methods can be considered as the method of setting the above-mentioned target limit. For example, it is possible to set the target limit based on the credit limit in the credit account which continues to exist after integration.

Also, for example, it is possible to set the same amount as the total sum of the credit accounts to be integrated as the target limit at the time of integration, and to lower the above-mentioned target limit stepwise until it comes down to the credit limit in the credit account which continues to exist after integration. In this way, even when the total sum of the outstanding credit-loan amounts in the credit accounts to be integrated does not exceed the credit limit in the credit account which continues to exist after integration, it is possible to prevent the substantial credit limit from being sharply lowered from the total sum of the credit limits in a plurality of credit accounts before integration.

Also, according to another embodiment of the present invention, an account management system which manages credit accounts comprises: an outstanding credit-loan management unit managing an outstanding credit-loan amount in a credit account; and a credit limit setting unit judging whether an outstanding credit-loan amount in the credit account after integration is larger than a target limit which is expected to be the credit limit in the credit account after integration; if it is judged that the outstanding credit-loan amount in the credit account after integration is larger than the target limit, setting an equal to or larger amount than the outstanding credit-loan amount as the credit limit in the credit account after integration; if it is judged that the outstanding credit-loan amount in the credit account after integration is equal to or smaller than the target limit, it sets the same amount as the target limit as the credit limit in the credit account after integration. By constituting the account management apparatus in such a way, the same function and effect as the above-mentioned account management method can be obtained, and the above-mentioned purpose can be also accomplished.

Furthermore, a computer data signal representing a program which makes a computer control the same procedure as that to be taken for the above-mentioned account management method can also accomplish the above-mentioned purpose by making the computer execute the program. In addition, a computer readable recording medium which records said program can also accomplish the above-mentioned purpose by making the computer read out the program from the recording medium and execute it.

### BRIEF DESCRIPTION OF THE DRAWINGS

The features and advantages of the present invention will be more clearly appreciated from the following description taken in conjunction with the accompanying drawings in which like elements are denoted by like reference numerals and in which:

FIG. 1 shows the substantial change of credit limits before and after two credit accounts are integrated into one credit account;

FIG. 2 shows the block diagram of a credit account management system;

FIG. 3 shows the data structure of a user ledger;

FIG. 4 is a flowchart of the procedure for processing the selection of credit accounts to be integrated;

FIG. 5 shows an example of an integrated-card selection screen;

FIG. 6 is a flowchart of the procedure for processing the designation of a refund method;

FIG. 7 shows an example of a refund method designation screen;

FIG. 8 is a flowchart of the procedure for processing the setting of a credit limit;

FIG. 9A shows an example of a refund schedule in which a user having two credit accounts refunds outstanding credit-loan amounts in both accounts in a revolving payment method (No. 1);

FIG. 9B shows the refund schedule in which even after the two credit accounts shown in FIG. 9A are integrated into one credit account, a substantial refund method does not differ from the refund methods in the credit accounts before integration (No. 1);

FIG. 9C shows the refund schedule in which the refund method of the credit account which continues to exist after the two credit accounts shown in FIG. 9A are integrated into one credit account is adopted in the credit account after integration (No. 1);

FIG. 10A shows an example of a refund schedule in which a user having two credit accounts refunds outstanding credit-loan amounts in both accounts in a revolving payment method (No. 2);

FIG. 10B shows the refund schedule in which even after the two credit accounts shown in FIG. 9A are integrated into one credit account, a substantial refund method does not differ from the refund methods in the credit accounts before integration (No. 2);

FIG. 10C shows the refund schedule in which the refund method of the credit account which continues to exist after the two credit accounts shown in FIG. 9A are integrated into one credit account is adopted in the credit account after integration (No. 2);

FIG. 11 shows the block diagram of a computer; and

FIG. 12 shows an explanation of a recording medium and a transmission signal which can supply data and a program to a computer.

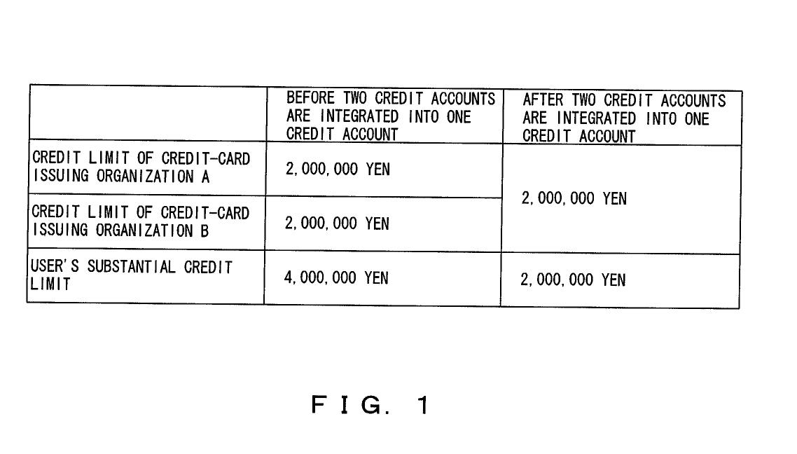

### DESCRIPTION OF THE PREFERRED EMBODIMENT

Described below is the embodiment of the present invention with reference to the accompanying drawings. Please note that like elements in the drawings are denoted by like reference numerals.

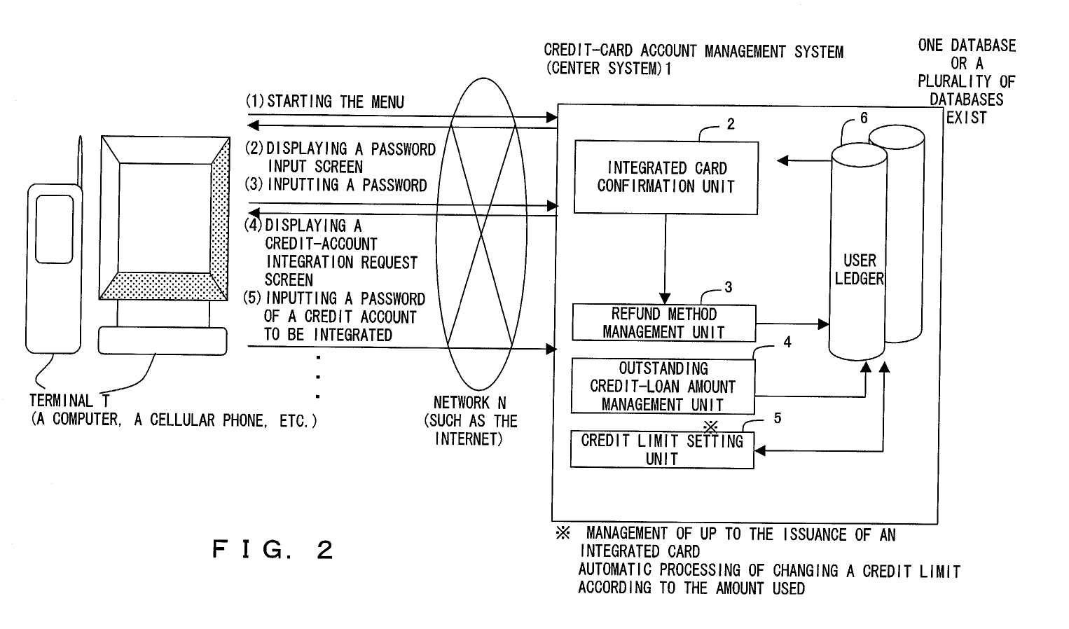

FIG. 2 shows the block diagram of a credit account management system related to the embodiment of the present invention. The credit account management system 1 is connected to a terminal T directly or via a network N, as shown in FIG. 2. The network N can be one network or a combination of a plurality of networks. WAN (Wide Area Network) and LAN (Local Area Network) such as the Internet, telephone line network, credit sale network, radio circuit network, etc. are considered as the network N. In FIG. 2, the credit account management system 1 and the terminal T are connected via the network N, but intend to limit the form of connecting the credit account management system 1 and the terminal T.

The user of the terminal T is the user of the credit account which the credit account management system 1 manages. The user accesses the credit account management system 1 using the terminal 1, and inputs the credit card number of the credit account, etc., so that he can confirm an outstanding credit-loan amount, set a refund method, or confirm a refund schedule or a credit limit. On-line terminals such as an ATM terminal and a KIOSK terminal (multimedia terminal), a desktop computer, a cellular phone, a PDA (Personal Digital Assistance), a laptop computer, etc. are considered as the terminal T. When a cellular phone is used as the terminal T, it is possible to use the network connection service for cellular phones such as i-mode (registered trademark of NTT Do-Co-Mo).

If the terminal T is a PDA, a cellular phone, a laptop computer, etc., there is an advantage in that the user can confirm the outstanding credit-loan amount, set the refund method, or confirm the refund schedule or the credit limit from anywhere and at any time

The credit account management system 1 integrates credit accounts, and outputs the outstanding credit-loan amount of the credit account after integration to the terminal T based on the input from the terminal T, or sets the refund schedule of the outstanding credit-loan amount and the credit limit based on the set refund method. The credit account management system 1 comprises an integrated-card confirmation unit 2, a refund method management unit 3, an outstanding credit-loan amount management unit 4, a credit limit setting unit 5, and a user ledger 6 as shown in FIG. 2.

The integrated-card confirmation unit 2 searches the user ledger 6 using a credit card number and a password inputted from the terminal T, and judges whether the user whose credit card number and password are identified as such has been registered in the user ledger, and then confirms that said user is the user of the credit accounts to be integrated. After that, the integrated-card confirmation unit 2 instructs the confirmed user to confirm the credit accounts to be integrated.

After the credit accounts to be integrated have been confirmed by the integrated-card confirmation unit 2, the refund method management unit 3 sets the refund method in the credit account after integration. To be more specific, the refund method management unit 3 judges whether the refund methods of the credit accounts before integration are changed owing to the integration of said accounts into one, and if it judges that the refund methods remain unchanged, it sets the refund method in the credit account after integration based on the refund methods of the credit accounts before integration. If it is judged that the refund methods in the credit accounts before integration are changed owing to the integration of the credit accounts into one, the refund method management unit 3 receives from the user the designation of the refund method of the outstanding credit-loan amount in the credit account after integration, and registers the designated refund method in the user ledger 6.

In other words, the refund method in the credit account after integration is not unilaterally changed by the credit card issuing organization, but can be changed based on the user's designation of the refund method in the credit account after integration. This makes it possible to decrease the inconveniences and disadvantages occurring to the user owing to the integration of credit accounts into one. There are refund methods such as a lump sum payment, an installment payment, a revolving payment, and a refund method in the credit account after integration may be selected from among the refund methods adopted before credit accounts are integrated.

When the user accesses the credit account management system 1, inputs his credit card number and password, and instructs the credit account management system 1 to confirm an outstanding credit-loan amount, the refund method management unit 3 obtains credit account data having said credit card number from the user ledger 6, and displays the refund schedule on the user's terminal T based on the credit account data.

The outstanding credit-loan amount management unit 4 manages an outstanding credit-loan amount by updating the outstanding credit-loan amount which is stored in the user ledger 6 at a specified timing when the user's credit card is used or an amount to be refunded is drawn out from the credit account.

If the credit card is given a plurality of functions such as a shopping function, a cashing function, and a loan service function, the outstanding credit-loan amount management unit 4 can control an outstanding credit amount in each of the said functions.

The credit limit setting unit 5 sets a credit limit in the credit account after integration based on the outstanding credit-loan amount stored in the user ledger 6. If the possibility of giving inconveniences and disadvantages to the user can be estimated to be low based on the outstanding credit-loan amount, the credit limit setting unit 5 sets the credit limit directly to a credit limit which is expected to be the one in the credit account after integration when a plurality of credit accounts are integrated into one.

Also, when an outstanding credit-loan amount before a plurality of credit accounts are integrated is larger than a credit limit which is expected to be the one in the credit account after integration, or in such other cases, if the credit limit in the credit account after integration is set to the expected credit limit when a plurality of credit accounts are integrated, the user has to refund the balance between the two in a lump sum, possibly causing him a lot of inconveniences and disadvantages. In this case, the credit limit setting unit 5 sets a credit limit in such a way that the credit limit is lowered stepwise until it comes down to the expected credit limit, based on the outstanding credit-loan amount stored in the user ledger 6. Since the refund method management unit 3 has set the refund method after a plurality of credit accounts are integrated based on the user's designation before the credit accounts are integrated, an outstanding credit-loan amount is the amount based on said refund method. It is possible, therefore, to set a credit limit so as not to cause the user a lot of inconveniences and disadvantages by setting a credit limit based on the outstanding credit-loan amount.

Also, the user who accesses the credit account management system 1 inputs his credit card number and password, and designates the confirmation of the credit limit after a plurality credit accounts are integrated, the credit limit setting unit 5 obtains credit account data having the inputted credit card number from the user ledger 6, and displays the present credit limit on the user's terminal T based on said credit account data. The credit limit can be also set for each individual function of shopping, cashing or loaning.

As has been described above, a credit limit is sometimes lowered stepwise. In this case, since the user can obtain the credit limit via a network, it is possible to direct the user's attention to the fact that the credit limit is stepwise lowered and to prevent the user from using the credit given to him too much.

The user ledger 6 stores personal information concerning each individual user and information concerning his credit account.

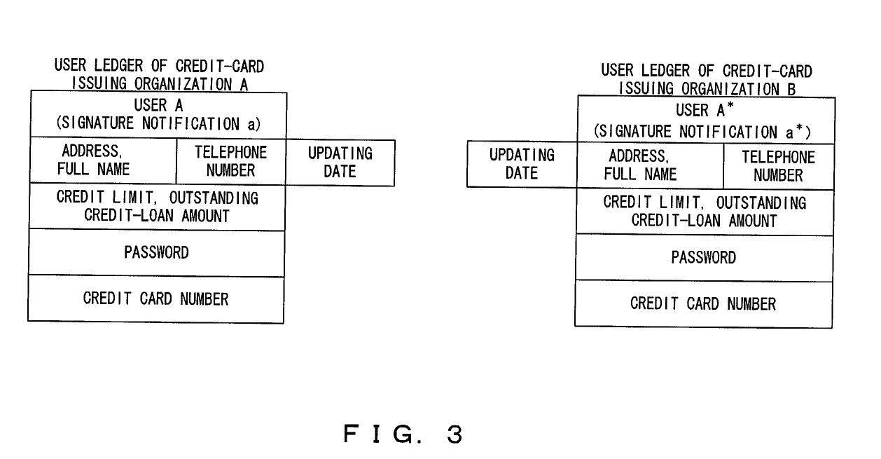

Described below is the data structure of the user ledger 6 with reference to FIG. 3. The user ledger 6 stores personal information about each individual user and information about his credit account with regard to both the credit account which continues to exist and the credit account which is abolished owing to the integration of the credit accounts, before a plurality of credit accounts are integrated into one. Also, after a plurality of credit accounts are integrated into one, the user ledger 6 stores the same information with regard to the credit account which continues to exist in the credit account after integration. In this case, it is possible to leave the information with regard to the credit account which continues to exist after integration as the information with regard to the credit account after integration, and to delete the information with regard to the credit account which is to be abolished when the outstanding credit-loan amount in the credit account which is to be abolished is completely refunded.

FIG. 3 shows an example of the data structure of a user ledger 6. For example, as shown in FIG. 3, the user ledger 6 maybe classified into both the credit-card issuing organization of the credit account which continues to exist and the credit-card issuing organization of the credit account which is abolished, after a plurality of credit accounts are integrated. In this case, data which is stored in the user ledger 6 is basically the same between the credit account which continues to exist and the credit account which is abolished.

The user ledger 6 stores credit account data. As shown in FIG. 3, credit account data includes various items such as credit-account card number, password, credit limit, outstanding credit-loan amount, data updated date, user's address, full name, telephone number, signature notification. The sequence of the items is arbitrary, but it can be in the order of, for example, credit card number, password, credit limit, outstanding credit-loan amount, data updated date, user's address, full name, telephone number, and signature notification, as shown in FIG. 3. Any number, other than a credit card number, which can be used as a number that can identify the credit account can be also used.

Credit card number, password, credit limit, user's address, full name, telephone number, signature notification are registered when a credit account is opened or a plurality of credit accounts are integrated, and are updated when it is required. An outstanding credit-loan amount is updated by the outstanding credit-loan amount management unit 4 when the user uses the credit account or refunds at least part of the outstanding credit-loan amount. Of course, the credit card number and password are not limited to a combination of numerals, but can be a combination of numerals, characters, and symbols.

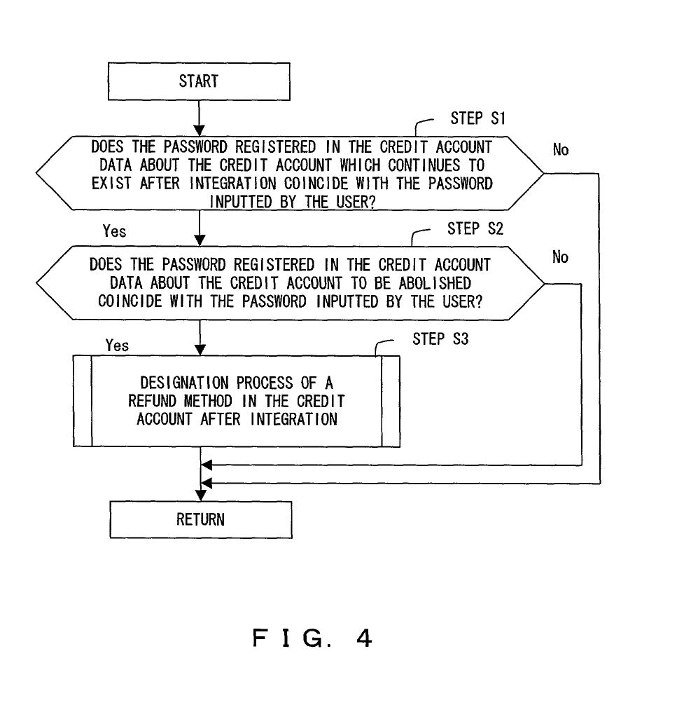

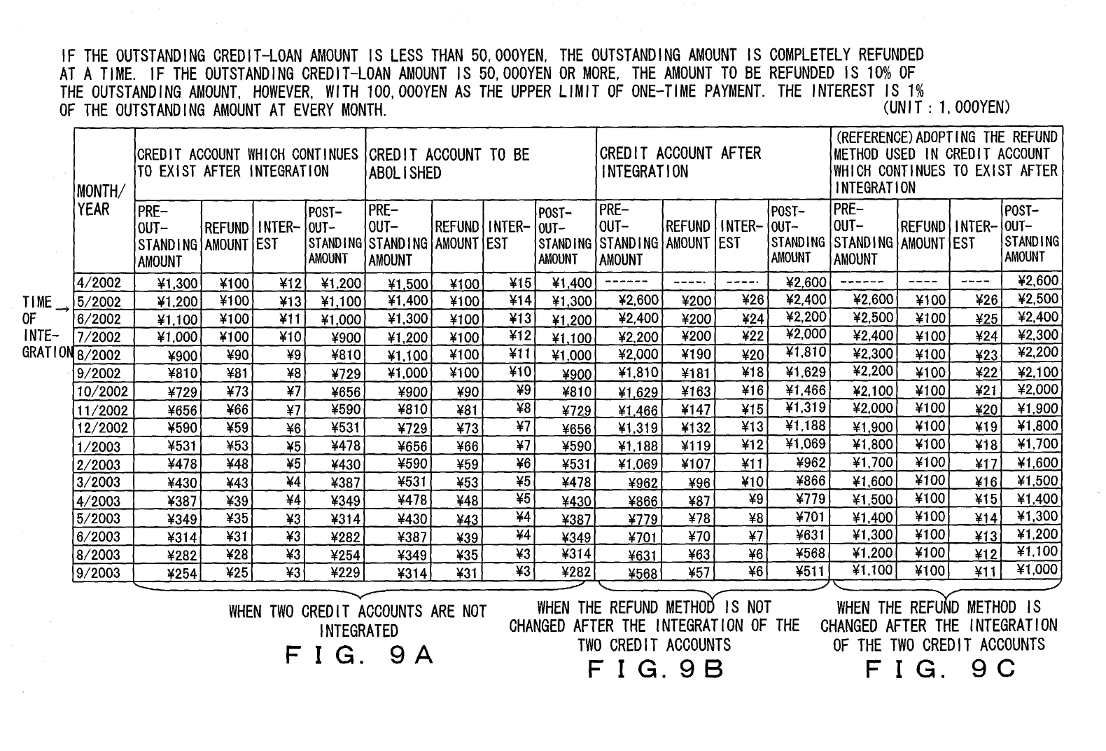

Described below is the processing procedure of the credit account management system 1 with reference to FIG. 4 and FIG. 9. In the following description, the credit account management system 1 is supposed to adopt GUI (Graphic User Interface), but that does not mean that the present invention is limited to a credit account management system which adopts GUI. Also, in the following description, the credit account management system 1 is supposed to transmit and receive information to and from the user via the network N, but that does not mean that the present invention is limited to it. Of course, the user can transmit and receive to and from the user using an input and output device (not shown in any figure) directly connected to the credit account management system 1. First, described below is the procedure for processing the selection of the credit accounts to be integrated with reference to FIG. 4. In the following description, credit card number is used as information for identifying a credit account.

Before designating a refund method after a plurality of credit accounts are integrated, the user selects the credit accounts to be integrated. For that sake, the user accesses the credit account management system 1 using the terminal T, and selects the process for selecting the credit accounts to be integrated from the processing menu (not shown in any figures). When the process for selecting the credit accounts to be integrated has been selected, the integrated-card confirmation unit 2 displays a screen in which the user's credit card number for the credit account which continues to exist after integration and the user's password are to be inputted on the user's terminal T. The user inputs information based on the instructions on the screen.

When receiving the credit card number of the credit account which continues to exist after integration and the password, the integrated-card confirmation unit 2 obtains credit account data from the user ledger 6 using the credit card number as a search key, and judges whether the password registered in the obtained credit account data coincides with the password which the user has inputted (step S1).

If the password registered in the credit account data does not coincide with the password which the user has inputted (step S1: No), the integrated-card confirmation unit 2 displays the fact that the password does not coincide on the user's terminal T, and terminates the selecting processing of the credit account. If the password registered in the credit account data coincides with the password which the user has inputted (step S1: Yes), the integrated-card confirmation unit 2 further obtains data in the credit account to be abolished in which the same information is registered from the user ledger 6, based on the information registered in the obtained credit account data such as the user's full name, address, etc.

In succession, the integrated-card confirmation unit 2 displays the credit card numbers in the obtained credit account data as an alternative of the credit account to be abolished on the user's terminal T, and instructs the user to select the credit account to be abolished. The user selects the credit account to be abolished, and inputs the password of that credit account. In the same way as step S1, the integrated-card confirmation unit 2, when receiving the credit card number of the credit account to be abolished and the password from the user, judges whether the password registered in the credit account data about the credit account to be abolished coincides with the password inputted by the user (step S2).

If the password registered in the credit account data does not coincide with the password inputted by the user (step S2: No), the integrated-card confirmation unit 2 displays the fact that the two passwords do not coincide on the user's terminal T, and terminates the processing of selecting the credit account. If the password registered in the credit account data coincides with the password inputted by the user (step S2:Yes), the integrated-card confirmation unit 2 processes the designated refund method (step S3), and terminates the processing of selecting the credit account.

It was mentioned in the above description that the integrated-card confirmation unit 2 would instruct the user to input the credit card number of the credit account which continues to exist after integration earlier than the credit account to be abolished, but it is quite possible, of course, to input the credit card number of the credit account to be abolished earlier than that of the credit account which continues to exist after integration.

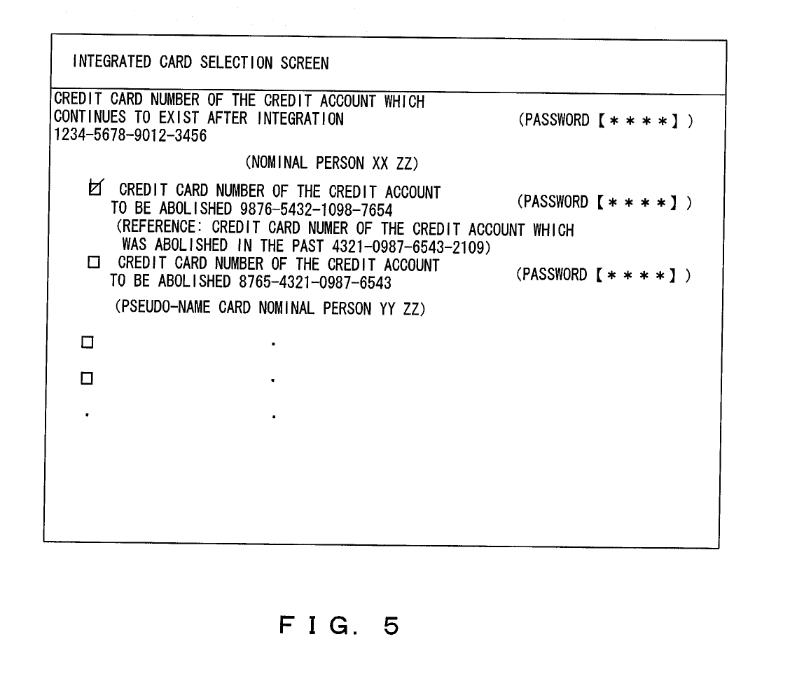

FIG. 5 shows an example of an integrated-card selection screen. The credit card number of the credit account which continues to exist after integration, the user's full name, and the alternatives of the credit account to be abolished after integration are displayed on the integrated-card selection screen as shown in FIG. 5.

Displayed on said screen as the alternatives of the credit account to be abolished are check boxes for selecting the credit card number of each credit card account, the user's full name, and the credit account. The user selects one credit account from the alternatives based on the instructions of the screen, and inputs the password for that credit account.

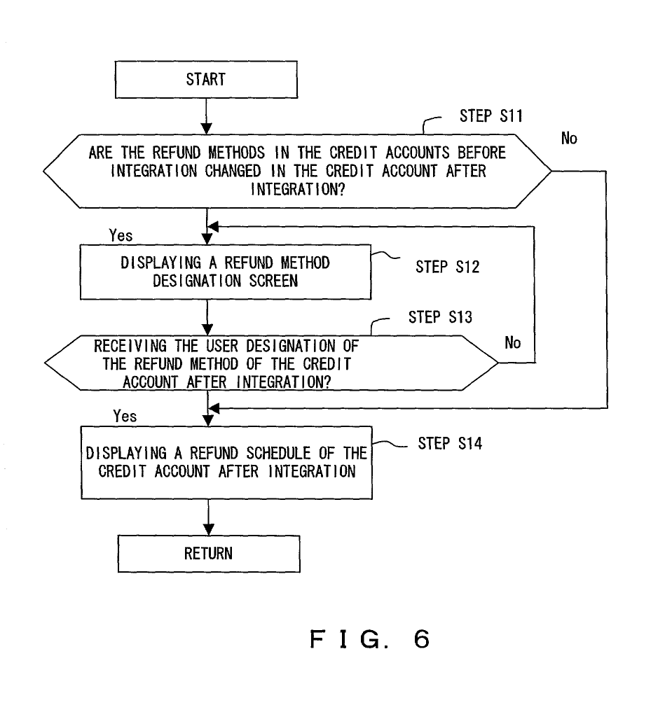

Next, described below is the procedure for processing the designation of a refund method with reference to FIG. 6. This processing corresponds to step S3 in FIG. 4. When a credit account to be integrated is selected in steps S1 and S2, the refund method management unit 3 sets a refund method after a plurality of credit accounts are integrated. Then, the refund method management unit 3 sums up both the outstanding credit-loan amounts in the credit account which continues to exist after integration and the outstanding credit-loan amount in the credit account to be abolished, and makes clear the outstanding credit-loan amount in the credit account after integration, and judges whether the refund methods which have been adopted before both the credit accounts are integrated are substantially changed after said credit accounts are integrated (step S11).

To be more specific, the refund method management unit 3 judges whether the amount which the user planned to refund every month before the integration of the credit accounts until the refund of the outstanding credit-loan amount is completely settled changes after the integration of the credit accounts by adopting the refund method in the credit account which continues to exist after integration as the refund method in the credit account after integration.

For example, let us suppose that before two credit accounts are integrated into one, the user refunds 100,000 yen each for both credit accounts every month in a revolving payment method with 100,000 yen as the upper refund limit per month, namely 200,000 yen in total for two credit accounts every month. After the two credit accounts are integrated into one, the user has to refund the outstanding credit-loan amount by 100,000 yen every month based on the refund method of the credit account which continues to exist after integration. Consequently, the refund method is changed owing to the integration of the credit accounts.

Also, let us suppose that the user has two credit accounts with a credit limit of 2,000,000 yen each and has an outstanding credit-loan amount of more than 2,000,000 yen in total for two credit accounts. If a substantial credit limit is lowered to 2,000,000 yen owing to the integration of the two credit accounts into one, the user is requested by the credit-card issuing organization to refund the amount exceeding 2,000,000 yen in a lump sum, thus causing the refund method to be changed.

Also, for example, if the user adopts a lump-sum payment method in a bonus-payment month before the two credit accounts are integrated into one, the same lump-sum payment method in a bonus-payment month is adopted after the two credit accounts are integrated, so that if the amount of the lump-sum payment is within the upper refund-amount limit, there is no change in the refund method between before and after the integration of the two credit accounts.

If the refund methods of the credit accounts before integration are not substantially changed (step S11: No) the refund method management unit 3 sets a refund method after the integration in the credit account data about the credit account which continues to exist after the integration, which is in the user ledger 6. In succession, the refund method management unit 3 makes a refund schedule in the credit account after integration based on the set refund method, displays the refund schedule on the user's terminal T (step S14), and terminates the processing of the designation of a refund method.

If the refund methods of the credit accounts before integration are substantially changed after the integration (step S11: Yes), the refund method management unit 3 displays a screen on which a refund method is designated on the user's terminal T (step S12), and waits for the user's designation of the refund method (step S13). Two alternatives are considered as the refund methods, as follows.

One alternative for the refund method is that as for the outstanding credit-loan amount in the credit account which continues to exist after integration, the refund method adopted in the credit account which continues to exist before the credit accounts are integrated is adopted even after the credit accounts are integrated, and as for the outstanding credit-loan amount in the credit account to be abolished, the refund method adopted before the integration in the credit account to be abolished is adopted even after the credit accounts are integrated so that the refund method may not change before and after the credit accounts are integrated. The other is to change the refund method in such a way that for the refund method of the outstanding credit-loan amount in the credit account after integration, the refund method adopt before integration in the credit account which continues to exist after integration is adopted in the credit account after integration.

The user designates a refund method in the credit account after integration based on the instructions on the screen. The refund method management unit 3, when receiving information for designating a refund method in the credit account after integration from the user (step S13: Yes), sets the refund method in the credit account after integration in the credit account data about the credit account which continues to exist after integration, which is in the user ledger 6, based on the designated refund method. Finally, the refund method management unit 3 makes a refund schedule in the credit account after integration, displays the refund schedule on the user's terminal T (step S14), and terminates the processing of the designation of a refund method.

After the refund method has been set, a refund amount is drawn out from the user's credit account according to the refund schedule based on the set refund method.

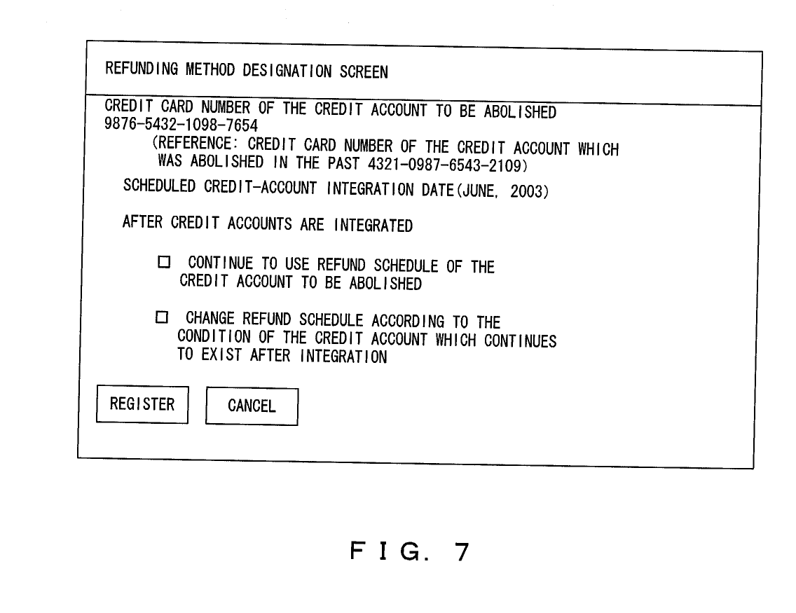

FIG. 7 shows an example of a refund method designation screen. Displayed on the refund method designation screen are the credit card number of a credit account to be abolished owing to the integration, the time when the credit accounts are expected to be integrated, alternatives for designating a refund method in the credit account after integration, a registration button and a cancellation button, as shown in FIG. 7.

Two alternatives as a refund method in the credit account after integration are shown in FIG. 7; “Refundment method in the credit account to be abolished is continuouslyused” and “Refundment schedule is changed according to the condition of the credit account which continues to exist after integration.” The former is the alternative in which a refund method does not change before and after the credit accounts are integrated, as mentioned above. The latter is the alternative in which the refund method of the outstanding credit-loan amount in the credit account after integration which is the total sum of both the outstanding credit-loan amount in the credit account which continues to exist and the outstanding credit-loan amount in the credit account to be abolished is changed based on the refund method of the credit account which continues to exist, as described above. When the user, after designating one of the displayed alternatives using the keyboard, pointing device, touch panel, etc., presses the registration button, the refund method management unit 3 sets the refund method in the credit account management system 1 based on the designation of the refund method. When the user presses (or selects) the cancellation button, the designation of the refund method is cancelled, and the screen goes back to a previous screen.

In this way, if, before the credit accounts are integrated, there is a possibility that a refund method is changed before and after the credit accounts are integrated, the user can designate either whether the user continues to refund the outstanding credit-loan amount after the integration of the credit accounts in the same way as he does before the integration of the credit accounts, or whether he changes a refund method based on the refund method adopted in the credit account which continues to exist, after the credit accounts are integrated. Therefore, it is made possible for the user to integrate the credit accounts while reducing the inconveniences and disadvantages he may suffer from the integration of the credit accounts.

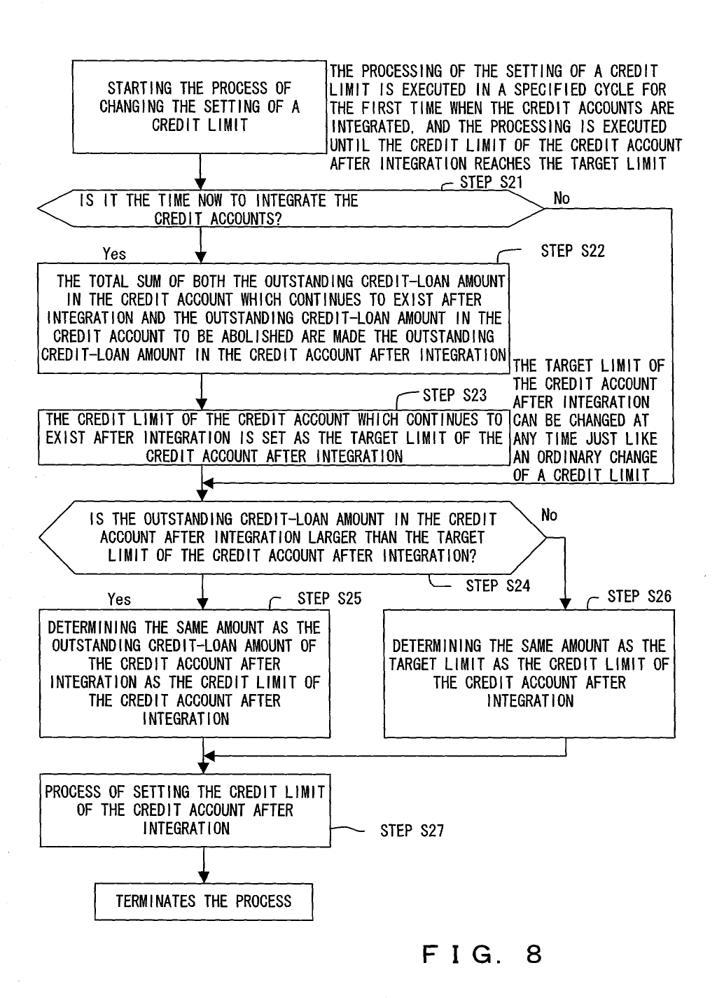

After the refund method is set, a credit limit is set based on the set refund method. Described below is the procedure for processing the setting of a credit limit with reference to FIG. 8. First, the credit limit setting unit 5 judges whether now is the time to integrate the credit accounts (step S21), as shown in FIG. 8. Please note that the time to integrate credit accounts has been set in the credit account management system 1 in advance.

If the credit limit setting unit 5 judges that now is not the time to integrate the credit accounts (step S21: No), the processing proceeds to step S24 (to be described later). If the credit limit setting unit 5 judges that now is the time to integrate the credit accounts (step S21: Yes), the credit limit setting unit 5 obtains credit account data about the credit accounts to be integrated from the user ledger 6, and calculates the total sum of both the outstanding credit-loan amount of the credit account which continues to exist and the outstanding credit-loan amount of the credit account to be abolished, and sets said total sum as the outstanding credit-loan amount of the credit account after integration (step S22). Then, the credit limit setting unit 5 successively sets the credit limit of the credit account which continues to exist after integration as a target limit which is expected to be a credit limit in the credit account after integration (step S23). Like the change of a credit limit at an ordinary time other than at the time when credit accounts are integrated, the target limit of the credit account after integration can be changed at any time.

The credit limit setting unit 5 judges whether the outstanding credit-loan amount in the credit account after integration is larger than the target limit (step S24). The outstanding credit-loan amount in the credit account after integration is calculated based on both the outstanding credit-loan amount in the credit account which continues to exist and the outstanding credit-loan amount to be abolished, when the credit accounts are integrated, and after the credit accounts are integrated, if the credit account after integration is used or if at least part of the outstanding credit-loan amount is refunded, the outstanding credit-loan amount is updated by the outstanding credit-loan amount management unit 4.

If the outstanding credit-loan amount of the credit account after integration is larger than the target limit (step S24: Yes), the credit limit setting unit 5 determines the same amount as the outstanding credit-loan amount in the credit account after integration as the credit limit of the credit account after integration (step S25), and the processing proceeds to step S27. If the outstanding credit-loan amount in the credit account after integration is not larger than the target limit (step S24: No), the credit limit setting unit 5 determines the same amount as the target limit as the credit limit in the credit account after integration (step S26).

Finally, the credit limit setting unit 5 registers the credit limit in the credit account after integration which is determined in step S 25 or S26 in the credit account data about the credit account after integration (step S27), and terminates the processing of the setting of the credit limit. The above-mentioned processing of the setting of the credit limit is executed for the first time when the credit accounts are integrated, and said processing is executed at a specified timing until the credit limit in the credit account after integration reaches the target limit. Considered as an example of “a specified timing” is “whenever the outstanding credit-loan amount is updated.”

Since the refund method in the credit account after integration has been set based on the user's designation by the refund method management unit 3 before the credit accounts are integrated, the outstanding credit-loan amount is the amount set based on said refund method. By setting the credit limit based on said outstanding credit-loan amount, while the user can refund the outstanding credit-loan amount based on the refund method which the user has designated, the credit-card issuing organization can set the credit limit in the credit account after integration to a target limit. That is to say, it is possible to set a credit limit without causing inconveniences and disadvantages to the user as much as possible.

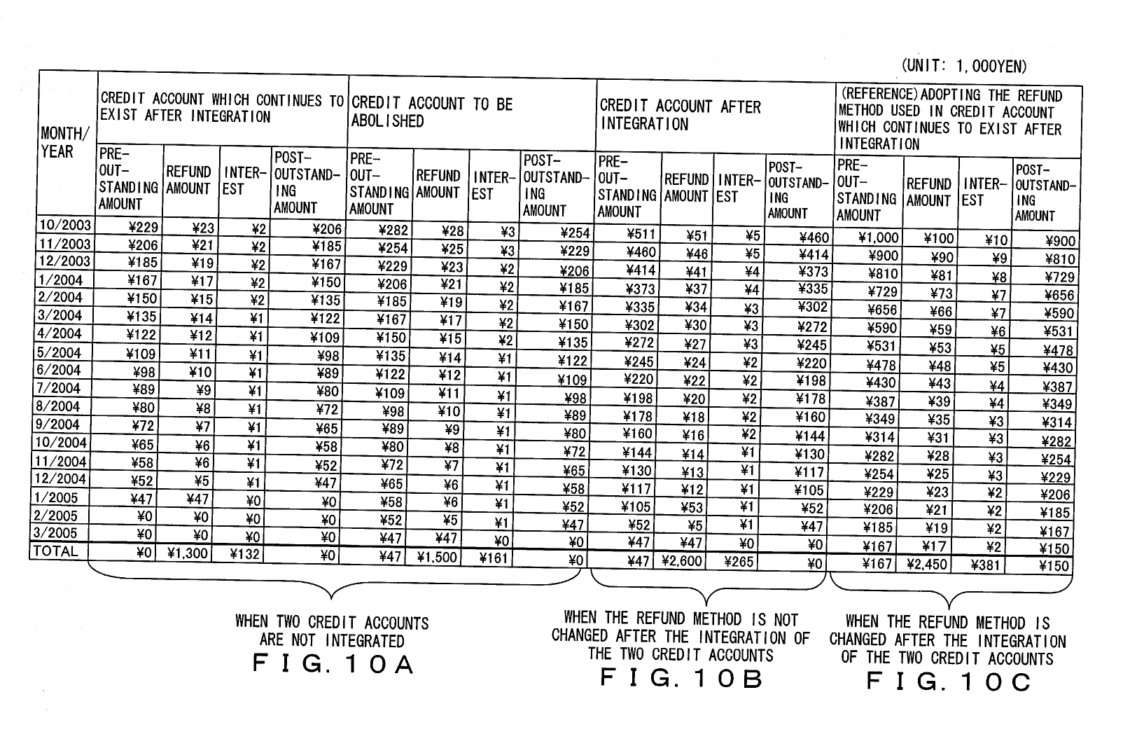

Described below are the refund method in the credit account after integration and the credit limit in the credit account after integration with reference to FIG. 9 and FIG. 10. FIG. 9 and FIG. 10 show examples of a refund schedule in which a user having two credit accounts refunds outstanding credit-loan amounts in both accounts in an outstanding-amount slide-revolving-payment method with 100,000 yen as an upper refund limit. Here, it is supposed that the slide amount is 10% of the outstanding credit-loan amount; when the outstanding amount comes down to 50,000 yen, said outstanding amount is to be completely refunded; and the interest is 1% of the outstanding amount every month. Please note, however, that the refund method is not limited to these examples.

Shown in FIG. 9 and FIG. 10 are three refund schedules as examples. The first is the refund schedule wherein a user having two credit accounts refunds an outstanding credit-loan amount of each credit account, as shown in FIG. 9A and FIG. 10A (when the two credit accounts are not integrated). The second is the refund schedule wherein even if the two credit accounts are integrated, the refund schedule does not substantially differ from that when the two credit accounts are not integrated, as shown in FIG. 9B and FIG. 10B. The third is the refund schedule wherein after the two credit accounts are integrated, the refund method is changed by adopting the refund method in the credit account which continues to exist after integration after the two credit accounts are integrated, as shown in FIG. 9C and FIG. 10C.

At first, the refund schedule shown in FIG. 9A and FIG. 10A id explained. For the credit account which continues to exist after integration out of the two integration-target credit accounts, the user pays, for example, in April 2002, 13,000 yen as the interest of the credit-loan amount which is outstanding as of the end of the previous month. Also, the user pays 100,000 yen, which is the upper refund limit out of 130,000 yen, namely 10% of 1,300,000 yen of the outstanding credit-loan amount. As a result, the outstanding credit-loan amount as of the end of April 2002 is 1,200,000 yen. In this way, if the user continues refunding the outstanding credit-loan amount in the credit account which continues to exist after integration, he can completely finish refunding the credit loan in January 2005. In other words, the user refunds 1,300,000 yen and pays 132,000 yen as interest by the time he finishes refunding the credit loan.

For the credit account to be abolished out of the two integration-target credit accounts, the user pays, for example, in April 2002, 15,000 yen as the interest of the credit-loan amount, 1,500,000 yen, which is outstanding as of the end of the previous month. Also, the user refunds 100,000 yen. Then, the outstanding credit-loan amount as of the end of April 2002 is 1,400,000 yen. The user can completely finish refunding the credit loan in March 2005. In other words, the user refunds 1,500,000 yen and pays 161,000 yen as interest by the time he finishes refunding the credit loan.

Next, the refund schedule shown in FIG. 9B and FIG. 10B is explained. In the case of the refund schedule shown in FIG. 9B and FIG. 10B, for the outstanding credit-loan amounts of both the credit account which continues to exist after integration and the credit account to be abolished, the refund methods adopted in both credit accounts as they are are adopted after the integration of both credit accounts so that the refund methods may not substantially change between before and after the integration of both credit accounts. Consequently, the monthly refund amount and interest of the credit account after integration equals the sum of the monthly refund amounts and interest of the two credit accounts shown in FIG. 9A and FIG. 10A, as shown in FIG. 9B and FIG. 10B.

To be more specific, for example, the refund amount and interest as of May 2002 in the credit account after integration are 200,000 yen and 26,000 yen respectively. These amounts are equal to the sum of the refund amounts and interest as of May 2002 in the two credit accounts shown in the refund schedule of FIG. 9A. Also, as shown in FIG. 10B, the refund finishing time is the same as that of the refund schedule shown in FIG. 10A, and the refund amount and interest that the user pays by the time he finishes refunding the credit loan amount are the same as those of the refund schedule shown in FIG. 10A. Therefore, according to the credit account management system 1, it is possible to integrate credit accounts without substantially changing the refund schedule that the user originally considered before the integration of the credit accounts.

There are some months in which the sum of the refund amounts in the refund schedules shown in FIG. 9A and FIG. 10A does not exactly equal the refund amount in the refund schedules shown in FIG. 9B and FIG. 10B. This inconsistency takes place due to an error arising from calculating the refund amounts in thousands based on rounding off less than one thousand yen to the nearest integer. It goes without saying that the inconsistency does not occur due to the intrinsic function of the credit account management system 1.

Finally, the refund schedule shown in FIG. 9C and FIG. 10C is explained. In the case of the refund schedule shown in FIG. 9C and FIG. 10C, after two credit accounts are integrated, the refund method of the credit account which continues to exist after integration is adopted in the credit account after integration. Taken as an example are the refund amount and interest as of May 2002. The outstanding credit-loan amount as of the end of the previous month in the credit account after integration in May 2002 is 2,600,000 yen, the sum of the outstanding credit amounts of the two credit accounts as of the end of April 2002 immediately before the two credit accounts are integrated. Consequently, the user pays 26,000 yen as the interest of 2,600,000 yen, the outstanding credit-loan amount as of the end of the previous month. Also, the user refunds 100,000 yen, which is the upper refund limit out of 260,000 yen, namely 10% of 2,600,000 yen of the outstanding credit-loan amount. As a result, the outstanding credit-loan amount as of the end of May 2002 is 2,500,000 yen. That is, after the two credit accounts are integrated, the substantial refund amount reduces from 200,000 yen to 100,000 yen.

If the user continues refunding the outstanding credit-loan amount in the credit account after integration, 1,500,000 yen still remains as the outstanding credit-loan amount as of May 2005. That means that since the refund finishing time is greatly delayed, the interest that the user has to pay becomes all the more large.

The outstanding credit-loan amount when the two credit accounts are integrated is 2,600,000 yen, the sum of the outstanding credit-loan amounts of the two credit accounts immediately before integration, as shown in the refund schedules of FIG. 9B and FIG. 10B and in the refund schedules of FIG. 9C and FIG. 10C. According to the credit account management system 1, even if the credit limit of the credit account which continues to exist after integration is 2,000,000 yen, the credit limit of the credit account after integration is not lowered to 2,000,000 yen at once. It is possible, therefore, to prevent the user from being requested by the credit-card issuing organization to refund the amount exceeding the credit limit which may be lowered owing to the integration of the two credit accounts.

As has been described above, the user designates a refund method before the credit accounts are integrated using the user's terminal T. When the user designates the refund method, a refund schedule based on the refund method is displayed on the user's terminal T. For example, if the user designates “Use the refund method of the credit account to be abolished” in the refund method designation screen shown in FIG. 7, the refund schedule shown in FIG. 9B and FIG. 10B is displayed on the user's terminal T. If the user designates “Change the refund method according to the condition of the credit account which continues to exist after integration” in the screen shown in FIG. 7, the refund schedule shown in FIG. 9C and FIG. 10C is displayed on the user's terminal T.

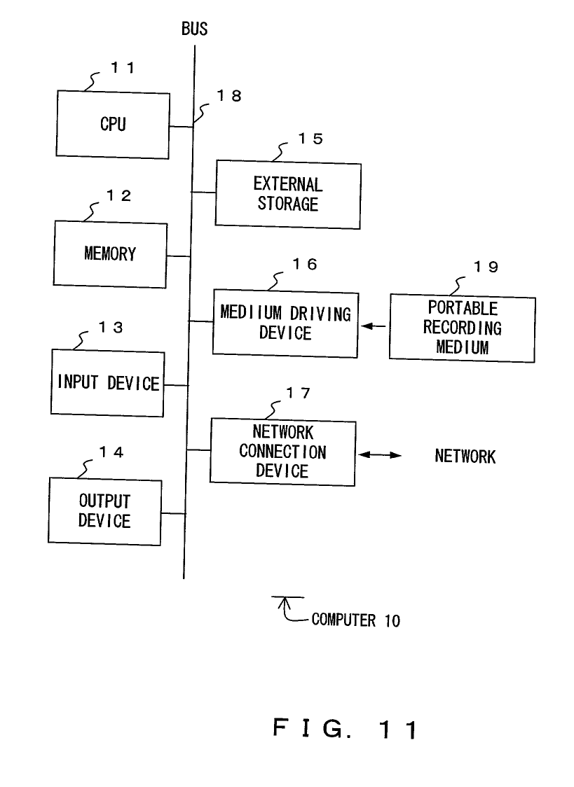

The terminal T and the credit account management system 1 which were explained in the above-mentioned embodiment can be constituted by a computer (information processing device) as shown in FIG. 11.

The computer 10 comprises a CPU 11, memory 12, an input device 13, an output device 14, an external storage device 15, a medium driving device 16 and a network connection device 17, and they are all connected by a bus 18.

The memory 12 may be, for example, ROM (Read Only Memory) and RAM (Random Access Memory), and stores a program and data which are used for processing. The CPU 11 carries out necessary processing by executing the program using the memory 12.

For example, the integrated card confirmation unit 2, the refund method management unit 3, the outstanding credit-loan amount management unit 4 and the credit limit setting unit 5 which constitute the credit account management system 1 related to the embodiment of the present invention are all stored as a program in a specified program code segment of the memory 12. The input device 13 is, for example, a keyboard, a pointing device, and a touch panel, and is used to input instructions and information from the user. The output device 14 is, for example, a display and a printer, and is used to output processing results and questions to the user of the computer 10.

The external storage device 15 is, for example, a magnetic disk device, an optical disk device, and a magnet-optical disk device. The above-mentioned program and data are stored in this external storage device 15, and can be loaded on the memory 12 as occasion arises.

The medium driving device 16 drives a portable recording medium 19, and access the recorded contents of the portable recording medium. Used as the portable recording medium 19 are any arbitrary computer readable recording media such as a memory card, a memory stick, a flexible disk, CD-ROM (Compact Disk Read Only Memory), an optical disk, a magnet-optical disk, and a DVD (Digital Versatile Disk). The above-mentioned program and data are stored in this portable recording medium 19, and can be loaded on the memory 12 as occasion arises.

The network connection device 17 communicates with an external apparatus via any arbitrary network N (line) such as LAN and WAN, and performs data conversion pursuant to the communication. Also, the network connection device 17 may receive the above-mentioned program and data from the external apparatus as occasion arises, and said program and data can be loaded on the memory 12.

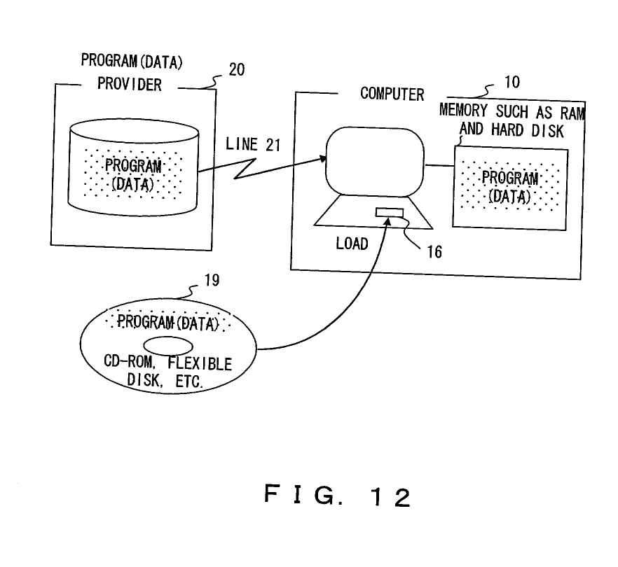

FIG. 12 shows an explanation of a computer readable recording medium and transmission signal which can supply a program and data to a computer shown in FIG. 11.

It is also possible to make a versatile computer execute the function corresponding to the credit account management system 1 which was explained in the above-mentioned embodiment. Such a constitution can be built in the following manner. First, in the flowchart of FIG. 4, FIG. 6, and FIG. 8 explained in the embodiment, the program which makes the computer execute the same processing as that which is executed by the credit account management system 1 is stored in the computer readable recording medium 19 in advance. Then, the computer 110 is made to read said program from the recording medium 19, and said program is once stored in the memory of the computer 10 or the external storage device 15, and then the CPU 11 which the computer 10 has is made to read the stored program and execute said program.

It is also possible to download the program from the database which the program (data) provider 20 has via the telecommunication line (network) 21 instead of making the computer 10 read the program from the recording medium 19. In this case, the computer for transmission which the program (data) provider 20 has converts the program data which represents the program to a program data signal, obtains a transmission signal by modulating the converted program data signal using a modem, and outputs the obtained transmission signal to a telecommunication line 21 (transmission medium). The computer which receives the program obtains a program data signal by demodulating the transmission signal which was received using a modem, and obtains program data by converting the program data signal. If the telecommunication line 21 (transmission medium) which connects the computer for transmission and the computer for receiving is a digital line, it is possible to communicate the program data signal. It is also possible for a computer of, for example, a telephone central office to intervene between the computer which transmits the program and the computer which downloads the program.

Each unit which constitutes the credit account management system 1 realizes a series of business processes by operating in concert with each other. Each unit and the user ledger (database) can be provided in the same server or can be provided in a different server to operate in concert with each other via a network.

Described below is a modification example of the above-mentioned embodiment. It has been already explained that when the credit limit setting unit 5 sets a credit limit of the credit account after integration, if the credit limit setting unit 5 judges that the outstanding credit-loan amount of the credit account after integration is larger than the above-mentioned target limit, the credit limit setting unit 5 sets the same amount as the outstanding credit-loan amount of the credit account after integration as the credit limit of the credit account after integration. It is possible, however, to set a larger amount than the outstanding credit-loan amount of the credit account after integration as the credit limit of the credit account after integration.

By so doing, the user does not have to change the refund method which he originally considered when he began using the credit card even after two credit accounts are integrated. Also, if the same amount as the outstanding credit-loan amount of the credit account after integration is set as the credit limit of the credit account after integration, the user has no usable amount until the outstanding credit-loan amount of the credit account after integration becomes smaller than the target limit. Such a situation can be avoided by setting a larger amount than the outstanding credit-loan amount as the credit limit of the credit account after integration. If an outstanding credit-loan amount management method is applied, the usable amount is the amount obtained by subtracting an outstanding credit-loan amount from a credit limit.

To be more specific, when the outstanding credit-loan amount of the credit account after integration is 3,000,000 yen, if the same amount is set as the credit limit of the credit account after integration, the usable amount is zero. However, if 3,000,000 yen to which, for example, 100,000 yen is added, namely 3,100,000 yen is set as the credit limit of the credit account after integration, the usable amount is 100,000 yen. In order to decrease the credit limit of the credit account after integration toward the target limit stepwise, the amount to be added should be preferably smaller than the refund amount at a previous refund time.

In the above-mentioned explanation, the target limit which is expected to be the credit limit in the credit account after integration was set as the credit limit of the credit account which continues to exist after integration. However, it is also possible to change the target limit in accordance with the lapse of time. For example, the target limit of the credit account after integration which is to be set when a plurality of credit accounts are integrated is set as the sum of the credit limits of a plurality of credit accounts, and after then the target limit is lowered stepwise in accordance with the lapse of time. It is thus possible to prevent the credit limit from being sharply lowered when the sum of the outstanding credit-loan amounts of the credit accounts to be integrated does not exceed the credit limit of the credit account which continues to exist, though the sum of the credit limits of a plurality of credit accounts is a substantial credit limit before a plurality of credit accounts are integrated.

As has been described in detail, according to the present invention, it is possible to manage a credit account while reducing the inconveniences and disadvantages which are caused to the user due to the integration of credit accounts.

While the present invention has been described with reference to the preferred embodiments thereof, various modifications and changes may be made by those skilled in the art without departing from the true spirit and scope of the present invention as defined by the claims thereof.

What is claimed is:

1. An account management method for managing credit accounts, comprising:
judging, when a plurality of credit accounts are integrated into one credit account, whether an outstanding credit-loan amount in the credit account after integration is larger than a target limit which is expected to be the credit limit in a credit account after integration;
setting an equal to or larger amount than the outstanding credit-loan amount as the credit limit in the credit account after integration, when it is judged that the outstanding credit-loan amount in the credit account after integration is larger than the target limit; and
setting the same amount as the target limit as the credit limit in the credit account after integration, when it is judged that the outstanding credit-loan amount in the credit account after integration is equal to or smaller than the target limit.

2. The account management method according to claim 1, further comprising:
updating the outstanding credit-loan amount in the credit account after integration at a specified timing; and
re-setting the credit limit in the credit account after integration by making the judgement based on the updated outstanding credit-loan amount, when the credit limit in the credit account after integration does not coincide with the target limit.

3. The account management method according to claim 1, further comprising:
when an equal to or larger amount than the outstanding credit-loan amount in the credit account after integration is set as the credit limit in the credit account after integration, gradually lowering the credit limit in the credit account after integration.

4. The account management method according to claim 1, further comprising:
receiving via a network the designation of a refund method for refunding the outstanding credit-loan amount in the credit account after integration from the user of the credit account;
calculating a refund schedule for refunding the outstanding credit-loan amount in the credit account after integration based on the refund method; and
informing the user of the refund schedule via a network.

5. The account management method according to claim 1, further comprising:
setting the target limit based on the credit limit in the credit account which continues to exist after integration.

6. The account management method according to claim 1, further comprising:
setting the same amount as the total sum of the credit accounts to be integrated as the target limit at the time of integration; and
gradually lowering the target limit until it comes down to the credit limit in the credit account which continues to exist after integration.

7. An account information acquisition method in which the terminal having the function of connecting to a network acquires information about a credit account from a server which manages the credit account, comprising:
transmitting to the server via a network the account identification number which identifies the credit accounts to be integrated and information which designates the refund method for refunding outstanding credit-loan amount in the credit accounts to be integrated, after integration; and
receiving information about a refund schedule of the outstanding credit-loan amount based on the refund method.

8. A computer data signal, embodied in a carrier wave, and representing a program which makes the computer control the credit account management, and the program making the computer execute the steps of:
judging, when a plurality of credit accounts are integrated into a credit account, whether an outstanding credit-loan amount in the credit account after integration is larger than a target limit which is expected to be a credit limit in the credit account after integration;
setting an equal to or larger amount than the outstanding credit-loan amount as the credit limit in the credit account after integration, when it is judged that the outstanding credit-loan amount in the credit account after integration is larger than the target limit; and
setting the same amount as the target limit as the credit limit in the credit account after integration, when it is judged that the outstanding credit-loan amount in the credit account after integration is equal to or smaller than the target limit.

9. An account management system for managing credit accounts, comprising:
an outstanding credit-loan management unit managing outstanding credit-loan amounts in credit accounts, and
a credit limit setting unit, judging, when a plurality of credit accounts are integrated into a credit account, whether the outstanding credit-loan amount in the credit account after integration is larger than a target limit which is expected to be a credit limit in the credit account after integration, when it is judged that the outstanding credit-loan amount in the credit account after integration is larger than the target limit, setting an equal to or larger amount than the outstanding credit-loan amount as the credit limit in the credit account after integration, and when it is judged that the outstanding credit-loan amount in the credit account after integration is equal to or smaller than the target limit, setting the same amount as the target limit as the credit limit in the credit account after integration.

10. A recording medium which records a program which makes a computer control the credit account management, and the program to make the computer perform the steps of:
when a plurality of credit accounts are integrated into a credit account, judging whether an outstanding credit-loan amount in the credit account after integration is larger than a target limit which is expected to be a credit limit in the credit account after integration;
setting an equal to or larger amount than the outstanding credit-loan amount as the credit limit in the credit account after integration, when it is judged that the outstanding credit-loan amount in the credit account after integration is larger than the target limit; and
setting the same amount as the target limit as the credit limit in the credit account after integration, when it is judged that the outstanding credit-loan amount in the credit account after integration is equal to or smaller than the target limit.
